(19) United States
(12) Patent Application Publication
(10) Pub. No.: US 2007/0126731 A1
(43) Pub. Date: Jun. 7, 2007

(54) Graphical architecture for handheld measurement system

(76) Inventor: Stephen R. Sabram, Campbell, CA (US)

Correspondence Address: Philip Virga, Suite 105, 1525 Aviation Blvd., Redondo Beach, CA, 90278, US

(21) Appl. No.: 11/296,520

(22) Filed: Dec. 6, 2005

(51) Int. Cl. G06T 1/00

(52) U.S. Cl. 345/418

(57) ABSTRACT

A method and system for providing a “framing” architecture which draws both real-time and post acquisition measurements such that multiple types of drawing objects can exist on the screen of a handheld computer at the same time independent of its exact location on the screen is disclosed. The “framing” architecture utilizes a drawing “pane” within the frame which may adjust its graphical “view” without dependence on the location of other panes within the frame nor the location of the frame on the handheld computer screen. In addition, the frame may be resized dynamically to adjust with the handheld computer user dynamically changing the size of the area within the handheld computer screen.

### CROSS-REFERENCE TO RELATED APPLICATIONS

Attention is directed to co-pending application U.S. application Ser. No. ______, filed Dec. 5, 2005, entitled, “Power Management for a Handheld Measurement System,” Attorney Docket No. S/S1000. The disclosure of this co-pending application is hereby incorporated by reference in its entirety.

### FIELD OF THE INVENTION

This invention relates generally to handheld measurement devices and, in particular, to user interfaces for handheld measurement devices.

### BACKGROUND

A typical handheld measurement system consists of software and simple hardware attachments for a given PDA (personal digital assistant) such as the Palm or handheld computer. Sensors are attached to the hardware, turning the Palm or handheld computer into a state-of-the-art, handheld test and measurement instrument. Handheld computing devices have become smaller and more powerful, thereby providing the user with unprecedented access to desired information when mobile. For example, wireless telephones and personal digital assistants (“PDAs”) equipped with wireless modems, when provided with the appropriate software, also permit the user to browse a network and look for information of interest.

Despite these advances in hardware and software, the sheer volume of measurement information from a plurality of sensors can overwhelm the user. Graphical user interfaces that provide multiple views of related measurement information (such as frames, panes, or screens) are prevalent in commercially available software products. These interfaces tend to facilitate user interaction with information presented. Unfortunately, current multi-view interfaces are severely limited by the lack of intuitive, hierarchical relationships between views, view placement and layout, and view presentation. These related views are typically ad hoc in their interaction and functionality. That is, there is little user level control over the relationships between views, view placement and layout, and view presentation, particularly for handheld measurement devices.

From the foregoing, it is apparent that there is still a need for a way to view large amounts of measurement information on a small screen in an efficient manner. It should be presented in an interface that is easy to navigate, but does not overwhelm the display device or frustrate the user due to loss of context or an excessive number of navigational steps.

### SUMMARY

A method and system for providing a “framing” architecture which draws both real-time and post acquisition measurements such that multiple types of drawing objects can exist on the screen of a handheld computer at the same time independent of its exact location on the screen is disclosed. The “framing” architecture utilizes a drawing “pane” within the frame which may adjust its graphical “view” without dependence on the location of other panes within the frame nor the location of the frame on the handheld computer screen. In addition, the frame may be resized dynamically to adjust with the handheld computer user dynamically changing the size of the area within the handheld computer screen.

When the frame is resized, the panes within the frame are automatically resized according to a paneling rule (grid, horizontal or vertical plus giving a “large” priority to a specific pane within the frame). Subsequently, the views in each pane are redrawn according to the height and width of its pane. These views can be manipulated by user's PDA-stylus taps within the view and updated via measurement hardware.

Other features and advantages will be apparent to one skilled in the art given the benefit of the following disclosure.

### BRIEF DESCRIPTION OF THE DRAWINGS

FIG. 1 is a plan front view of a measurement sled of the present invention;

FIG. 2 is a side view of the measurement sled of FIG. 1;

FIG. 3 is a planar side view illustrating the measurement sled attaching to a handheld computer or PDA;

FIG. 4 is a plan front view of a handheld computer or PDA with the measurement sled connected and attached underneath forming a handheld measurement system;

FIG. 5 illustrates a system level block diagram of the handheld measurement system connected to a desktop computer;

FIG. 6 is a pictorial representation of a graphical user interface utilizing frames and panes on the handheld computer or PDA for use with the measurement sled;

FIG. 7 is a pictorial representation of the graphical user interface illustrating an example of varying the frames and panes on the handheld computer or PDA;

FIG. 8 is a pictorial representation of the graphical user interface illustrating another example of varying the frames and panes on the handheld computer or PDA; and

FIG. 9 is a flowchart illustrating one embodiment of the method for the frame management dynamics illustrated in FIGS. 8 through 10.

### DETAILED DESCRIPTION OF THE DRAWINGS

Most PDAs (personal digital assistants) have the ability to have a “sled” attached to the bottom/back of the device. Typically, a sled is used for a wired or wireless communications device such as a modem or Ethernet connection. Referring to FIGS. 1 through 4 there is shown a small, lightweight peripheral or sled 20 that attaches securely to the back of a PDA device 30 which by way of example may be a Palm handheld. When combined with the software of the present invention, the appropriate cable, and environmental sensors such as a user's ICP® accelerometers for example, it becomes the first complete, PDA-based multipurpose instrument 18 for vibration analysis and analog data acquisition for ICP accelerometers and other sensors, as shown in FIG. 4. By adapting a stock plastic case and placing inside a micro-controller-based, analog-to-digital converter system to which sensors are attached an entire measurement system combining PDA, sled, and sensors provide for a wide range of test and measurement applications.

Although not shown in the figures, it should be understood that the design approach is to use a “split board” design within the sled wherein one end of the board is the “logic board,” which holds the micro-controller or DSP (digital signal processor) and communicates with the PDA. The other end of the board is the “interface board,” which holds the analog or digital electronics to communicate with the sensors. Although the boards are fabricated as one, they are designed so that the two ends can be cut apart and rejoined with multi-contact connectors. This allows for the possibility of new logic-board designs and/or new interface-board designs being created and joined with existing designs while minimizing design, fabrication, and assembly time and costs.

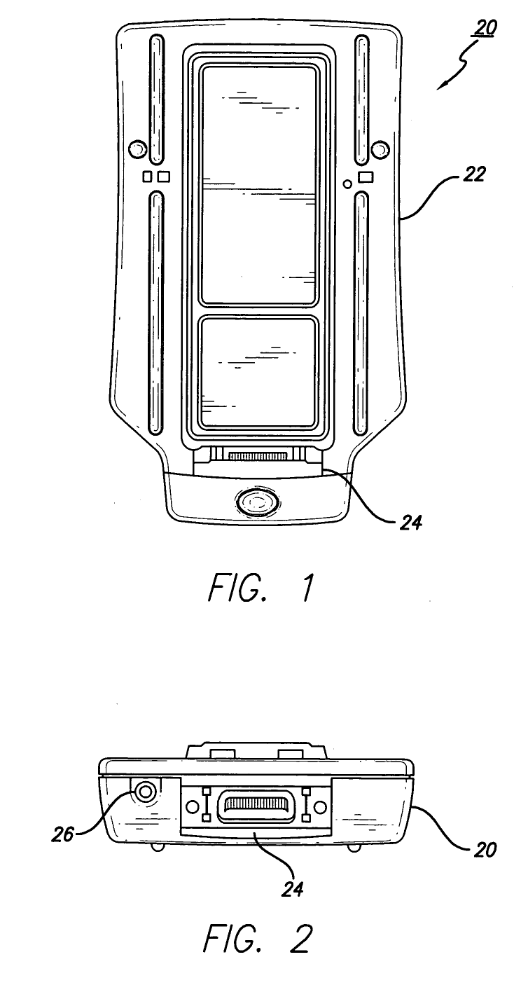

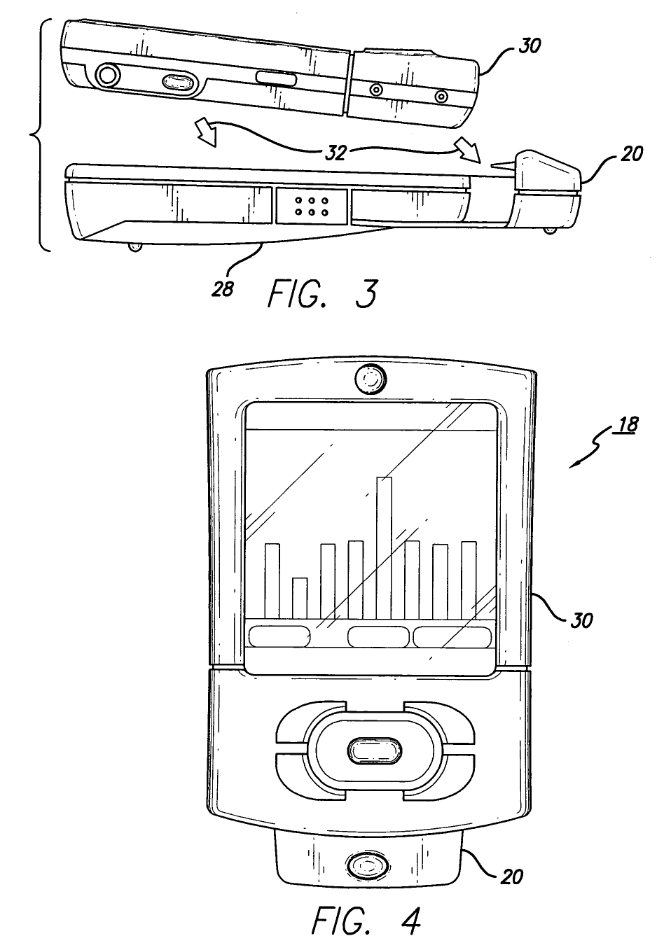

Referring once again to FIGS. 1 through 4, the measurement sled 20 may provide from four to eight single-ended analog inputs and provides one 16-bit digital counter, one TTL-level digital-switch input line, and two TTL-level digital-switch output lines. As shown in FIGS. 3 and 4, the measurement sled 20 firmly attaches and de-attaches to any Palm™ Tungsten™ T, T2, T3 30, or C or Garmin iQue 3200 or iQue 3600 handheld by utilizing mechanical hooks 22 and hook releases 28. High-impedance inputs ensure compatibility with almost any active analog sensor. An integrated 20-pin connector 24 features a harpoon latch for a more secure connection and is shielded for low noise. The measurement sled 20 may be powered by a pair of on-board AAA alkaline batteries (not shown) or by an optional external power supply through power connector port 26 as shown in FIG. 2.

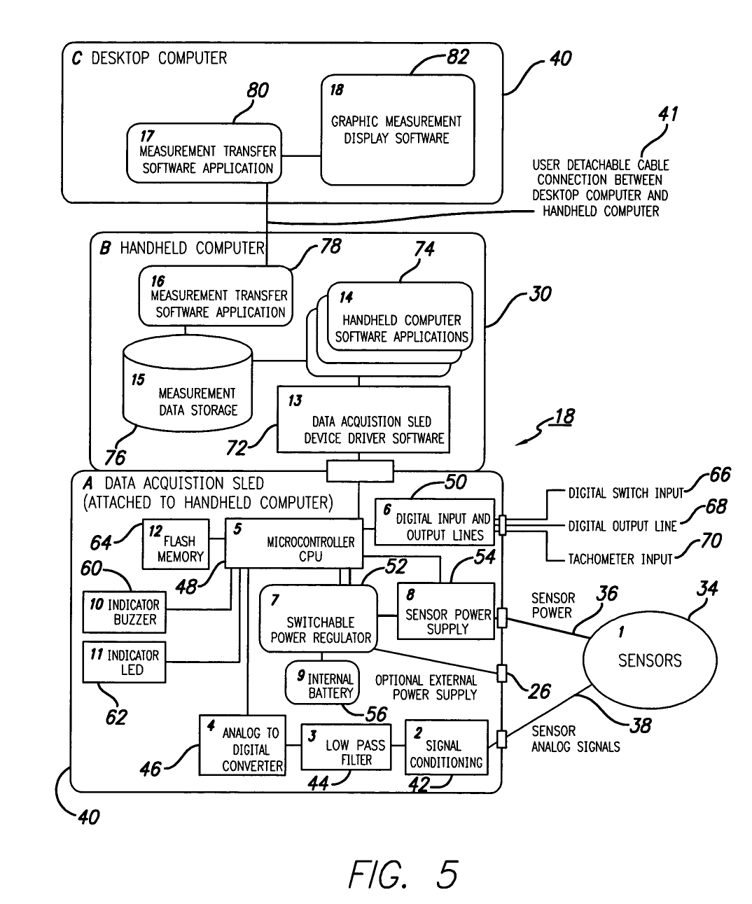

FIG. 5 illustrates a system level block diagram of the PDA sled-based instrumentation architecture 18 connected to a desktop computer 40. Overall, the object of the systems architecture is to utilize a handheld computer 30 to read and store sensor readings using a larger desktop or laptop computer 40 as a “post collection” tool to reduce the weight of equipment used in portable instruments. The architecture 18 also lets the measurements be moved from the handheld computer 30 to the desktop computer 40 for display. A step-by-step description of this process follows.

General-purpose sensors 34 such as pressure, acceleration, temperature and humidity are connected to the data acquisition or measurement sled 20. These sensors 34 connect electrically as sensor analog signals 38 to the sled 20 where the sensors' measurement electrical characteristics are converted into a readable voltage via signal conditioning 42. The conditioned signal is then moved through a low pass filter 44 that may be utilized as an anti-alias filter to remove false signals. This now conditioned and filtered signal is read by an analog to digital converter 46 that is controlled by the sled's 20 primary micro-controller 48. The micro-controller 48 reads the digitized signal and performs signal processing such as time-average filtering, signal linearization, digital filtering and even a Fast Fourier Transform. Once these signal-processed readings are made by the micro-controller 48, the signals are stored in one of two ways. They are either stored within the sled's 20 internal flash memory 64 that allows for high speed measurements (in the kilohertz) or sent to a data acquisition sled device driver software 72 and stored in the handheld computer 30.

The micro-controller 48 also drives an indicator buzzer 60 and an indicator LED 62 that may be used for operational cues to the user of the handheld computer 30. These cues are messages such as resetting of the firmware, connection or disconnection of communications to the handheld computer 30 or completion of a major operation in the firmware such as a specific mathematical transform upon sensor signals.

Turning once again to FIG. 5 the sled 20 is powered in two ways. Primarily, an internal battery 56 powers the micro-controller 48, signal conditioning and, optionally, the sensors 34. The sensors 34 are powered by a specific sensor power supply circuit 54 that is controlled by a switchable power regulator 52. The switchable power regulator 52 in turn is controlled by the micro-controller 48. In those instances when a sensor is not powered directly by the sled 20, the sensors power can be controlled by a digital output line 68 via a digital input and output lines controller 50. These digital IO lines (digital switch input 66 and digital output lines 68) may be used in many ways. One feature that has shown to have significant advantage is the implementation of a tachometer input 70 that can be read along with the connected analog sensors 34.

The handheld computer 30 runs various handheld computer software applications 74, which directly interface with the data acquisition sled driver software 72 that in turn communicates with the sled 20. These handheld computer software applications 72 can both display and store measurements read from the data acquisition or measurement sled 20. The measurements are stored in persistent measurement data storage 76 volumes that are either internal to the handheld computer 30 or removable by the user. The measurement data held in the measurement data storage 76 is moved to a desktop or laptop computer 40 in one of two ways. One way is, if the measurement data storage 76 is a removable media connected to the handheld computer 30, the removable media can be physically detached from the handheld computer 30 and then attached to the desktop or laptop computer 40. The second way, which is the most common, is to connect the handheld computer to the desktop computer via a user detachable cable 41. This cable 41 lets the measurement transfer software applications 78 of the handheld computer 30 and the desktop computer 40 to communicate with each other and starts the transfer of measurement data from the handheld computer 30 to the desktop computer 40.

Once the measurement data is transferred to the desktop computer, graphic measurement display software 82 reads the measurement files now stored on the desktop or laptop computer 80 for text and graphical display. At this point, the user now can further manipulate the measurement data with user provided software for their specific task. While many aspects of the sled 20 exist in other third party products, a novel and effective power management for the data acquisition hardware sled 20 is provided. This is mostly done with the handheld computer 30 supervising the timing of the sled's sensor power 36 instead of it being directly controlled by the sled's micro-controller 48 as is known in the art of power or battery management for handheld devices.

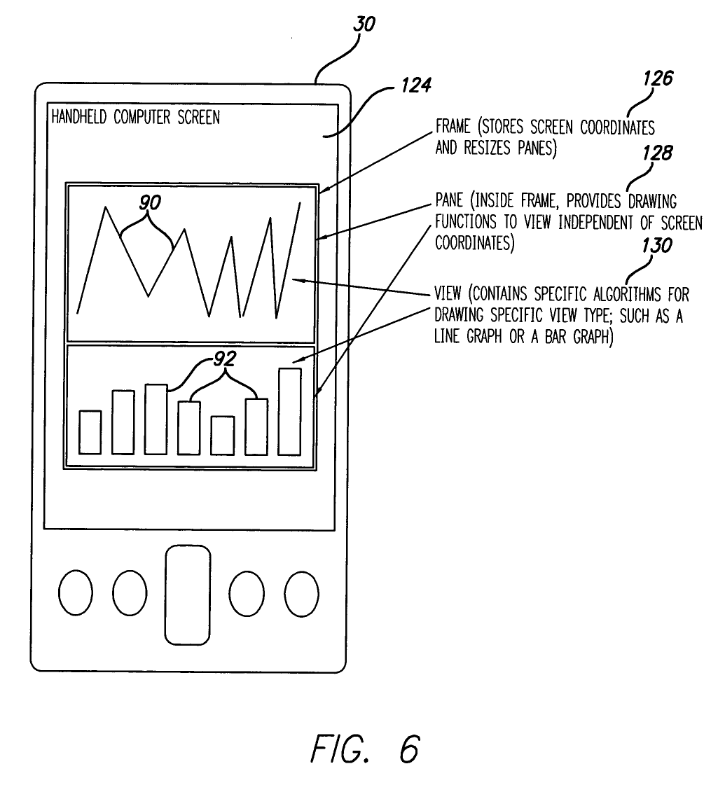

FIG. 6 is a pictorial representation of a graphical user interface utilizing frames 126 and panes 128 on a handheld computer or PDA 30 for use with the measurement sled. FIGS. 6 through 9 illustrate in general the overall graphic architecture to fully utilize the small footprint of a handheld computer's display screen 124. While large screen, desktop computers use an overlapping window scheme where users can click on a window to overlap on top of each other this does not work well on handheld computers.

The primary operational difference between handheld and desktop computers is that, unlike desktop computers, the attention of the user is not fully on a handheld computer when it is in use. When a graphical user interface is designed for a handheld computer that shows multiple graphical objects, partially covered views are very confusing. With using a handheld computer 30, there is no “click and explore” moment from the users attention to the screen for viewing a graphical object. The graphical object must always be fully shown for immediate and clear comprehension.

With this in mind, a graphic architecture is provided that allows multiple graphical objects of different types to be resized according to the various small and user adjustable screen footprints of various models of handheld computers in common use today. To make a graphic scheme like this work, it was necessary to replace the traditional overlapping window graphical mechanism. Thus, the overlapping window metaphor was replaced with a single window metaphor. This single window 124 is broken up into separate windowpanes 128. In each pane 128, is a separate view 130 that allows the user to “see through the pane” as shown in FIG. 6.

Referring to FIG. 6, the frame 126 of the window 124 occupies a part of the handheld computer screen. The frame object 126 holds the screen coordinates of the window 124. The frame 126 holds one or more panes 128 that subdivide the frame 126. The pane object 128 holds drawing functions independent of their position in the frame to draw a view 130. The view object contains the specific drawing methods for a specific type of view. For example, the diagram above shows two different views 130 being drawn in their respective panes 128. One is a line graph 90 while the other is a bar graph 92.

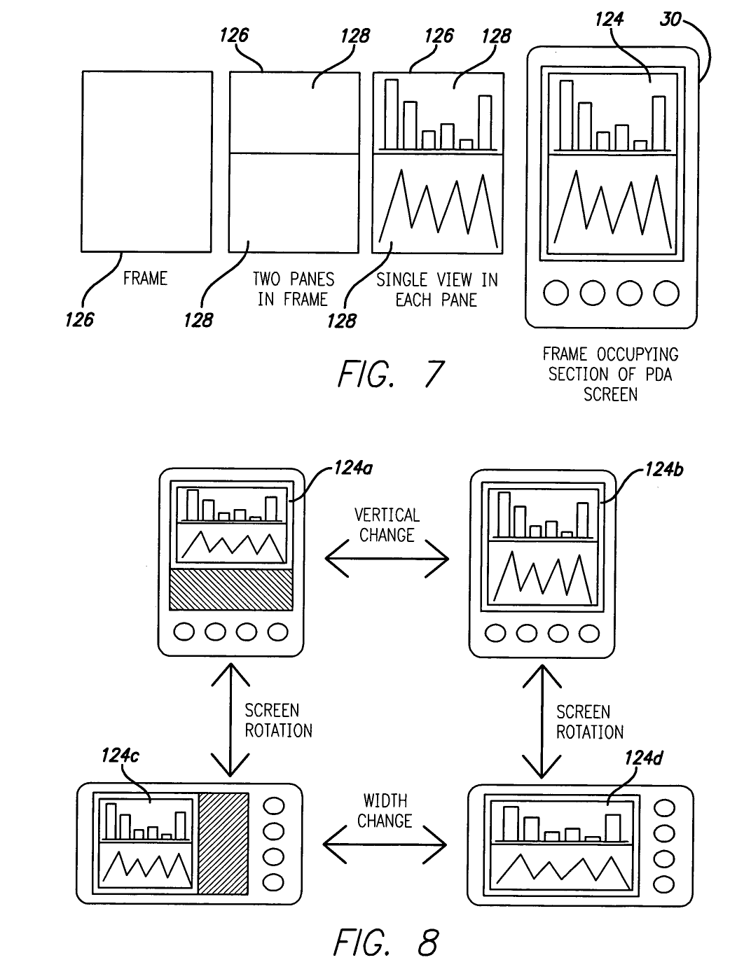

FIG. 7 is a pictorial representation of the graphical user interface illustrating an example of varying the frames 26 and panes 128 on the handheld computer or PDA 30. The frame 126 may then be repositioned or resized wherein the panes 128 are resized and the view 130 is instructed by the software routine to redraw within the new pane 130 positions. This allows for very quick and responsive updates on a handheld screen. Also, the frame takes in stylus taps and sends these tap events to the proper view for handling. These stylus taps are also localized to where the view does not need to know the screen coordinates taped but only the position within the view.

The frame is also responsible for managing new panes and views added or removed from it. FIG. 8 is a pictorial representation of the graphical user interface illustrating another example of varying the frames and panes on the handheld computer or PDA. The arrangement of the panes can follow three different scheme of horizontal arrangement of panes, vertical stacking of panes or a “smart” mode where the relative height and width of the frame is taken into consideration and the screens are arranged as needed upon the encoded heuristic arrangement functions. Also, a single pane can be designated as “big” where it will occupy anywhere from 40% to 60% of the frame space considering on the frame relative height and width.

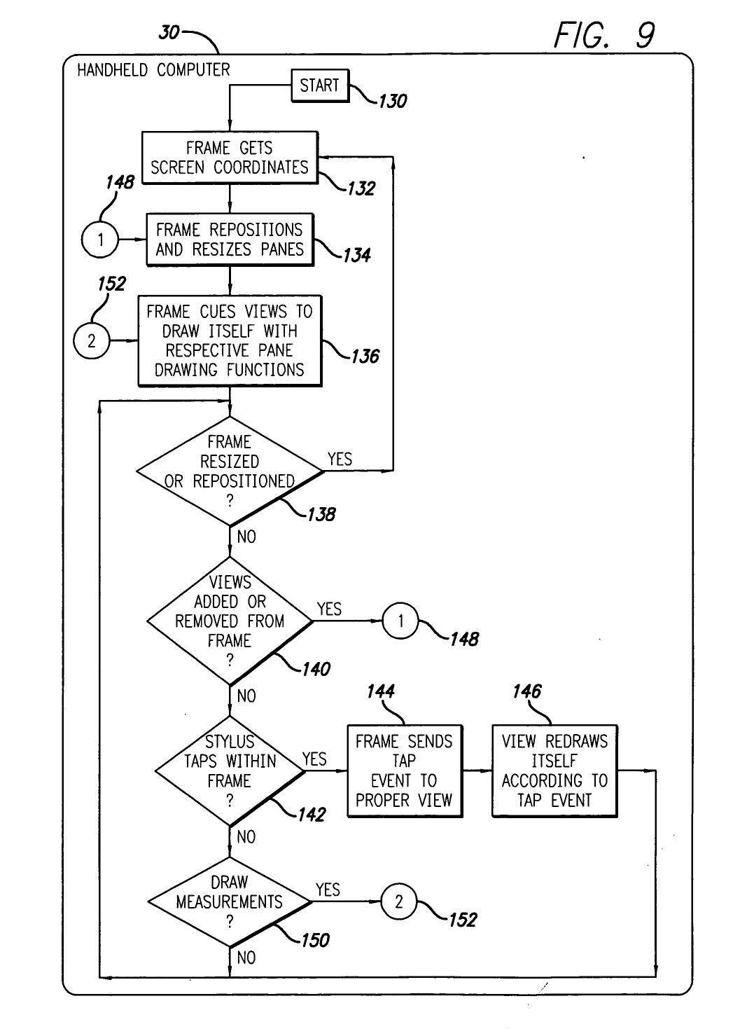

FIG. 9 is a flowchart illustrating one embodiment of the method for the frame management dynamics illustrated in FIGS. 8 through 10. The software routine for displaying the graphical user interface resides on the firmware within the handheld computer 30. The software routine starts 130 by retrieving 132 the screen coordinates for a given frame. Based on the frame coordinates the panes are then repositioned and resized 134. Next, the frame cues views to draw itself with respective pane drawing functions 136. The software routine then checks whether the frame has correctly resized or repositioned 138 and if it has the frame retrieves the next set of screen coordinates.

If the frame is not correctly resized or repositioned 138 then the software routine checks to see if views have been added or removed from the frame 140. If the views have been added or removed from the frame 148 then the frame repositions and resizes the panes 134 and continues the process until the frame is properly resized or repositioned. If no views have been added or removed from the frame 140 then the software routine checks to see if there are stylus taps within the frame by the user 142. If there is stylus taps within the frame, the frame sends the tap event to the proper view 144. The view then redraws itself according to the tap event 146 and then checks to see if the frame is resized or repositioned wherein the process repeats itself until the frame is correctly resized and repositioned 138. Once correctly resized and repositioned the frame waits until it gets screen coordinates 132.

Turning once again to FIG. 9, if the frame has not been resized or repositioned 138 and views have not been added or removed from the frame 140 and there is no stylus taps within the frame 142, the software routine checks to see if measurements have been drawn 150. If no measurements have been drawn the process repeats itself until the event of the frame needing resizing or repositioning, views added or removed or a stylus taps within the frame. If however measurements have been drawn 152 the frame cues the views to draw itself with respective drawing functions and the process once again repeats itself until the event of the frame needing resizing or repositioning, views added or removed or a stylus taps within the frame.

Described above is a method for providing a graphical user interface which allows both real-time and post acquisition measurements to be shown such that multiple types of drawing objects can exist on the screen of a handheld computer at the same time. The graphical user interface utilizes a drawing “pane” within the frame which may adjust its graphical “view” without dependence on the location of other panes within the frame nor the location of the frame on the handheld computer screen. In addition, the frame may be resized dynamically to adjust with the handheld computer user dynamically changing the size of the area within the handheld computer screen.

When the frame is resized, the panes within the frame are automatically resized according to a paneling rule (grid, horizontal or vertical plus giving a “large” priority to a specific pane within the frame). Subsequently, the views in each pane are redrawn according to the height and width of its pane. These views can be manipulated by user's PDA-stylus taps within the view and updated via measurement hardware.

The invention may be embodied in other specific forms without departing from its spirit or essential characteristics. The described embodiments are to be considered in all respect only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A method for providing a “framing” architecture which draws both real-time and post acquisition measurements such that multiple types of drawing objects may exist on a screen of a handheld computer at the same time independent of its exact location on the screen comprising:
utilizing a drawing pane within a frame wherein the frame may adjust its graphical “view” without dependence on the location of other panes within the frame nor the location of the frame on the handheld computer screen.

2. The method for providing a “framing” architecture according to claim 1, further comprising:
dynamically resizing the frame to adjust when the handheld computer user dynamically changes the size of the area within the handheld computer screen.

3. The method for providing a “framing” architecture according to claim 2, further comprising:
dynamically repositioning the frame to adjust when the handheld computer user dynamically changes the size of the area within the handheld computer screen.

4. The method for providing a “framing” architecture according to claim 1, further comprising:
automatically resizing the panes within the frame when the frames are resized according to a paneling rule.

5. The method for providing a “framing” architecture according to claim 4, wherein the paneling rule gives a larger priority to a specific pane based on grid, horizontal and vertical requirements.

6. The method for providing a “framing” architecture according to claim 5, wherein the views in each pane are redrawn according to the height and width of its pane.

7. The method for providing a “framing” architecture according to claim 1, further comprising:
manipulating views by user's PDA-stylus taps within the view and updated via measurement hardware.

8. A method for providing a graphical user interface for displaying both real-time and post acquisition measurements such that multiple types of drawing objects may exist on a screen of a handheld computer at the same time independent of its exact location on the screen comprising:
utilizing a drawing pane within a frame wherein the frame may adjust its graphical view without dependence on the location of other panes within the frame.

9. The method for providing a graphical user interface according to claim 8, further comprising:
dynamically resizing the frame to adjust to dynamic changes in a size of an area within the handheld computer screen.

10. The method for providing a graphical user interface according to claim 9, further comprising:
dynamically repositioning the frame to dynamic changes in a size of the area within the handheld computer screen.

11. The method for providing a graphical user interface according to claim 10, further comprising:
automatically resizing the panes when the frames are resized.

12. The method for providing a graphical user interface according to claim 11, wherein the specific pane is resized based on grid, horizontal and vertical requirements.

13. The method for providing a graphical user interface according to claim 12, wherein views in each pane are redrawn according to height and width.

14. The method for providing a graphical user interface according to claim 1, further comprising:
manipulating views by a user's PDA-stylus taps within a view and updated via measurement hardware.

15. A system for providing a “framing” architecture which draws both real-time and post acquisition measurements such that multiple types of drawing objects may exist on a screen of a handheld computer at the same time independent of its exact location on the screen comprising:
means for utilizing a drawing pane within a frame wherein the frame may adjust its graphical “view” without dependence on the location of other panes within the frame nor the location of the frame on the handheld computer screen.

16. The system for providing a “framing” architecture according to claim 15, further comprising:
means for dynamically resizing and repositioning the frame to adjust when the handheld computer user dynamically changes the size of the area within the handheld computer screen.

17. The system for providing a “framing” architecture according to claim 15, further comprising:
means for automatically resizing the panes within the frame when the frames are resized according to a paneling rule.

18. The system for providing a “framing” architecture according to claim 17, means for giving a larger priority to a specific pane based on grid, horizontal and vertical requirements.

19. The system for providing a “framing” architecture according to claim 18, means for redrawing the views in each pane according to the height and width of its pane.

20. The system for providing a “framing” architecture according to claim 15, further comprising:
means for manipulating views by user's PDA-stylus taps within the view and updated via measurement hardware.
